(19) United States
(12) Patent Application Publication
(10) Pub. No.: US 2025/0316739 A1
(43) Pub. Date: Oct. 9, 2025

(54) DRYING APPARATUS FOR MANUFACTURING RECHARGEABLE BATTERY

(71) Applicant: Samsung SDI Co., Ltd., Yongin-si (KR)

(72) Inventors: Jaesoon Jang, Yongin-si (KR); Kyeongbeom Cheong, Yongin-si (KR)

(73) Assignee: Samsung SDI Co., Ltd., Yongin-si (KR)

(21) Appl. No.: 19/009,800

(22) Filed: Jan. 3, 2025

(30) Foreign Application Priority Data
Apr. 3, 2024 (KR) 10-2024-0045528

(51) Int. Cl. H01M 10/04; H01M 4/04; H01M 10/613; H01M 10/615; H01M 10/6563

(52) U.S. Cl. CPC H01M 10/04; H01M 4/0471; H01M 10/613; H01M 10/615; H01M 10/6563

(57) ABSTRACT

A drying apparatus for manufacturing a rechargeable battery of the present disclosure includes: a hot air supply portion that supplies a hot air to an electrode plate; and a cold air supply portion that supplies a cold air to both sides along a width direction of the electrode plate.

### CROSS-REFERENCE TO RELATED APPLICATIONS

This present application claims priority to and the benefit under 35 U.S.C. § 119 (a)-(d) of Korean Patent Application No. 10-2024-0045528, filed on Apr. 3, 2024, in the Korean Intellectual Property Office, the entire disclosure of which is incorporated herein by reference.

### FIELD

The present disclosure relates to a drying apparatus for manufacturing a rechargeable battery.

### BACKGROUND

A rechargeable battery is manufactured in various shapes. A pouch battery among the rechargeable battery includes an electrode assembly with a separator that is an insulator interposed between a positive electrode plate and a negative electrode plate, and a thin flexible pouch in which the electrode assembly is embedded. In this circumstance, the pouch accommodates the electrode assembly in an inner space thereof.

The electrode assembly of the rechargeable battery is largely classified into a winding type and a stacking type according to a structure thereof. The stacking type has good structural safety and excellent spatial utility, so that it is widely applied to small and medium-sized types. The rechargeable battery with the stacking type is a battery in which a plurality of electrodes and a separator are stacked.

In a process of manufacturing the rechargeable battery, a drying apparatus is used to dry a wet coating electrode. In the drying apparatus used to dry the electrode, a nozzle directly affects a drying quality of the electrode.

The nozzle may basically supply a uniform temperature, wind volume, and wind speed to the electrode, but because different process conditions are applied to an area of each drying furnace depending on a design of the electrode, a case in which drying deviations in a width direction of the electrode may differently appear may frequently occur.

Particularly, a difference in a drying rate between an end portion of a width of the coating and a central portion of the coating may occur, and as the difference increases, a problem may occur in a quality of a manufactured electrode.

### SUMMARY

The present disclosure is to overcome the conventional problem described above, and an object of the present disclosure is to provide a rechargeable battery in which an entire electrode plate may be uniformly dried.

However, a technical problem to be solved by the present disclosure is not limited to the problem, and other technical problems not mentioned may be clearly understood by those skilled in the art from a description of the present disclosure below.

A drying apparatus for manufacturing a rechargeable battery according to embodiments of the present disclosure for solving the technical problem includes: a hot air supply portion that supplies a hot air to an electrode plate; and a cold air supply portion that supplies a cold air to both sides along a width direction of the electrode plate.

The cold air supply portion may include: a first body member that is coupled to one side of the hot air supply portion; a second body member that is coupled to another side of the hot air supply portion; and a cold air supply member that is connected to the first body member and the second body member and supplies a cold air to the first body member and the second body member.

Each of the first body member and the second body member may include: a cold air storage portion in which the cold air supplied from the cold air supply member is stored; a cold air guide portion that communicates with the cold air storage portion and protrudes from a portion of the cold air storage portion adjacent to the electrode plate; and a cold air spray portion that is disposed at one side of the cold air guide portion to spray the cold air stored in the cold air storage portion.

The cold air spray portion may be disposed on a surface of the cold air guide portion facing the hot air supply portion.

The cold air spray portion may have a slit shape.

A portion of the cold air guide portion adjacent to the electrode plate may be inclined downwardly as the portion of the cold air guide portion adjacent to the electrode plate gradually approaches the hot air supply portion.

The hot air supply portion may include: a hot air body member that is coupled to the first body member and the second body member; and a hot air supply member that is connected to the hot air body member and supplies a hot air to the hot air body member.

The hot air body member may include: a hot air storage portion in which the hot air supplied from the hot air supply member is stored; a hot air guide portion that communicates with the hot air storage portion and protrudes from a portion of the hot air storage portion adjacent to the electrode plate; and a hot air spray portion that is disposed at one side of the hot air guide portion to spray the hot air stored in the hot air storage portion.

The hot air spray portion may be disposed on a surface of the hot air guide portion facing the cold air supply portion.

The hot air spray portion may have a slit shape.

A portion of the hot air guide portion adjacent to the electrode plate may be inclined downwardly as the portion of the hot air guide portion adjacent to the electrode plate gradually approaches the cold air supply portion.

A temperature of a gas sprayed from the cold air supply portion may range from 30 degrees above zero to 10 degrees below zero.

The drying apparatus for manufacturing the rechargeable battery may further include: a measurement member that measures a length in the width direction of the electrode plate; and an interval adjustment portion that adjusts an interval between the first body member and the second body member based on a length value measured by the measurement member.

The first body member and the second body member may be slidably coupled to the hot air supply portion.

The measurement member may include a laser module that measures the length value by irradiating the electrode plate with a laser.

The measurement member may include: a camera module that acquires image data by photographing the electrode plate; and an image processing portion that calculates the length value by analyzing the image data acquired by the camera module.

The interval adjustment portion may include: a first shaft member that is coupled to the first body member; a second shaft member that is coupled to the second body member; and a driving member that moves the first shaft member and the second shaft member so that the first body member and the second body member are moved away from or close to the interval adjustment portion.

The drying apparatus for manufacturing the rechargeable battery may further include a temperature sensor that is installed adjacent to the electrode plate and measures temperatures of a central portion and both sides of the electrode plate.

The drying apparatus for manufacturing the rechargeable battery may further include a control portion that is electrically connected to the temperature sensor and the cold air supply portion and adjusts a temperature of the cold air sprayed from the cold air supply portion so that the temperatures of the central portion and the both sides of the electrode plate reach a target temperature based on a temperature value measured by the temperature sensor.

The drying apparatus for manufacturing the rechargeable battery may further include a control portion that is electrically connected to the temperature sensor and the hot air supply portion and adjusts a temperature of the hot air sprayed from the hot air supply portion so that the temperatures of the central portion and the both sides of the electrode plate reach a target temperature based on a temperature value measured by the temperature sensor.

The drying apparatus for manufacturing the rechargeable battery according to the present disclosure may include a cold air supply portion, so that it uniformly dries compared with a conventional drying apparatus. For example, a drying quality of an electrode plate may be adjusted through thermal balance by adding a cold air to both sides of the electrode plate that receive relatively more heat than a central portion thereof.

### BRIEF DESCRIPTION OF THE DRAWINGS

The drawings attached to the present specification illustrate embodiments of the present disclosure and serve to further understand a technical idea of the present disclosure together with a detailed description of the present disclosure to be described later, so that the present disclosure should not be construed as being limited to a matter described in the drawings.

FIG. 1 is a perspective view showing a drying apparatus for manufacturing a rechargeable battery according to embodiments of the present disclosure.

FIG. 2 is a cross-sectional view taken along a line II-II of the drying apparatus for manufacturing the rechargeable battery of FIG. 1.

FIG. 3 is a perspective view showing a drying apparatus for manufacturing a rechargeable battery according to other embodiments of the present disclosure.

FIG. 4 is a block diagram showing a measurement member included in the drying apparatus for manufacturing the rechargeable battery.

FIG. 5 is a view showing a process in which the measurement member measures a length in a width direction of an electrode plate.

FIG. 6 is a view showing a state before a first body member and a second body member become close to each other by an interval adjustment portion.

FIG. 7 is a view showing a state in which the first body member and the second body member become close to each other by the interval adjustment portion.

FIG. 8 is a block diagram showing a drying apparatus for manufacturing a rechargeable battery according to other embodiments of the present disclosure.

FIG. 9 is a graph showing an experimental result comparing a remaining amount of a solvent according to a region of the electrode plate dried by the drying apparatus according to the embodiments with a remaining amount of a solvent according to a region of an electrode plate dried by a drying apparatus according to a comparative example.

### DETAILED DESCRIPTION

Below, embodiments of the present disclosure will be described in detail with reference to the attached drawings. A term or a word used in the present specification and claims should not be construed as limited to its usual or dictionary meaning, and should be interpreted as a meaning and a concept conforming to a technical idea of the present disclosure based on a principle that an inventor may properly define a concept of the term to describe his or her invention in the best way. Thus, the embodiments described in the present specification and a configuration shown in the drawings are only examples of the present disclosure and do not represent all of the technical idea of the present disclosure, so that it should be appreciated that there may be various equivalents and variations that may replace the embodiments and the configuration at a time at which the present application is filed.

A term “comprises”, “includes”, “comprising”, or “including” when used in the present specification, specifies presence of a shape, a number, a step, an operation, a member, an element, and/or a group thereof, but does not preclude presence or addition of one or more other shape, one or more other number, one or more other operation, one or more other member, one or more other element, and/or a group thereof.

Additionally, to help understanding of the present disclosure, the attached drawings may not be shown at an actual scale, and dimensions of some components may be exaggerated in the drawings. In addition, the same reference number may be assigned to the same component in different embodiments.

When it is described that two objects are identical, this means that the objects are “substantially identical”. Therefore, the substantially identical objects may include objects having deviations considered low in the art, for example, deviations within 5%. Additionally, when it is described that certain parameters are uniform in a predetermined region, this may mean that the parameters are uniform in terms of an average.

Although terms “first”, “second”, and the like are used to describe various components, the components are not limited by the terms. The terms are only used to distinguish one component from another component, and unless otherwise stated, the first component may be the second component.

Throughout the specification, unless otherwise stated, each component may be singular or plural.

Disposing any component at an “upper portion (or lower portion)” of or “on (or below)” another component may mean not only that the component is disposed in contact with an upper surface (or lower surface) of the other component but also that another component may be interposed between the other component and the component disposed on (or below) the other component.

Additionally, when it is described that a component is “connected”, “coupled”, or “accessed” to another component, the components may be directly connected or accessed to each other, but it should be understood that another component may be “interposed” between the components or the components are “connected”, “coupled”, or “accessed” through another component.

A term “and/or” used in the present specification includes any and all combinations of one or more of the associated listed items. Additionally, a use of “may” when the embodiments of the present disclosure described are described refers to “one or more embodiments of the present disclosure”. An expression such as “one or more” preceding a list of components modifies an entire list of components and does not modify an individual component of the list.

Throughout the specification, when referring to “A and/or B”, it means A, B, or A and B, unless specifically stated to the contrary, and when referring to “C to D”, unless otherwise specified, it means that it is greater than or equal to C and less than or equal to D.

When a phrase such as “at least one of A, B, and C”, “at least one of A, B, or C”, “at least one selected from the group of A, B, and C”, or “at least one selected from A, B, and C” is used to specify a list of elements that are A, B, and C, the phrase may refer to all suitable combinations.

A term “use” may be considered synonymous with a term “utilize”. Terms “substantially,” “about,” and similar terms used in the present specification are used as terms of approximation rather than terms of degree, and are intended to consider intrinsic variation in a measured or calculated value that will be recognized by those skilled in the art.

Although terms “first”, “second”, “third”, etc. may be used in the present specification to describe various elements, components, regions, layers, and/or sections, the elements, components, regions, layers, and/or sections should not be limited by the terms. The terms are only used to distinguish one element, component, region, layer, or section from another element, component, region, layer, or section. Thus, a “first” element, component, region, layer, or section discussed below may be termed a “second” element, component, region, layer, or section without departing from teachings of the embodiments.

Spatially relative terms such as “beneath”, “below”, “lower”, “above”, “upper”, and the like may be used herein for ease of description to describe a relationship between one element or feature to another element(s) or feature(s) as shown in the drawings. It will be understood that the spatially relative terms are intended to encompass different directions of a device in use or operation in addition to a direction depicted in the drawings. For example, if a device shown in the drawings is turned over, an element described as “below” or “beneath” another element may be understood to “above” the other element. Thus, the term “below” may encompass directions of both above and below.

The terms used in the present specification are intended to describe the embodiments of the present disclosure, and are not intended to limit the present disclosure.

Hereinafter, a drying apparatus for manufacturing a rechargeable battery according to embodiments of the present disclosure will be described in detail with reference to the attached drawings.

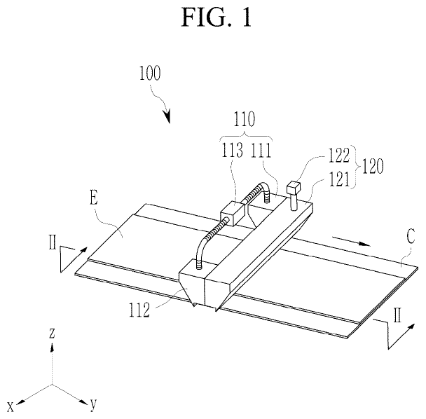

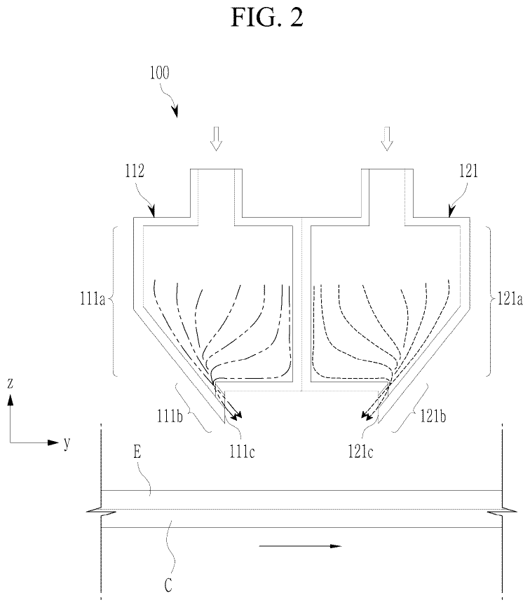

FIG. 1 is a perspective view showing a drying apparatus for manufacturing a rechargeable battery according to embodiments of the present disclosure, and FIG. 2 is a cross-sectional view taken along a line II-II of the drying apparatus for manufacturing the rechargeable battery of FIG. 1.

Referring to FIG. 1 and FIG. 2, the drying apparatus 100 for manufacturing the rechargeable battery according to the embodiments of the present disclosure may include a hot air supply portion (or a hot air supply unit) 120 and a cold air supply portion (or a cold air supply unit) 110.

The hot air supply portion 120 may supply a hot air to an electrode plate (E). The hot air may dry a solvent remaining on the electrode plate (E). A detailed description of the hot air supply portion 120 will be provided later. The electrode plate (E) may be transferred by a conveyor apparatus (C). The hot air supply portion 120 may be disposed above the electrode plate (E). In a process of transferring the electrode plate (E) to one direction (a y-direction), the hot air may be supplied from the hot air supply portion 120.

The cold air supply portion 110 may supply a cold air to both sides of a width direction (an x-direction) of the electrode plate (E). For example, the hot air may be supplied to a central portion of the electrode plate (E), and both the hot air and the cold air may be supplied to both sides of the electrode plate (E). Both sides based on the width direction of the electrode plate (E) may be dried relatively faster than a central portion thereof. However, as described above, the cold air may be sprayed at both sides of the electrode plate (E), so that a drying speed of both sides of the electrode plate (E) is reduced.

For example, the cold air supply portion 110 for this purpose may include a first body member 111, a second body member 112, and a cold air supply member 113.

The first body member 111 may be coupled to one side of the hot air supply portion 120.

The second body member 112 may be coupled to the other side of the hot air supply portion 120. The second body member 112 may have a size and a shape corresponding to those of the first body member 111. The second body member 112 may be spaced apart from the first body member 111 by a predetermined distance.

Each of the second body member 112 and the first body member 111 may be disposed to face both sides of the electrode plate (E).

The cold air supply member 113 may be connected to the first body member 111 and the second body member 112, and may supply the cold air to the first body member 111 and the second body member 112. For example, the cold air supply member 113 may include a rotation fan (not shown). As the rotation fan rotates, an air with a room temperature may be generated. Alternatively, the cold air supply member 113 may be an apparatus that includes a compressor and an evaporator to generate a cold air.

The cold air supply member 113 may supply a cold air to the first body member 111 and the second body member 112. The cold air supplied to the first body member 111 may be sprayed to one side of the electrode plate (E), and the cold air supplied to the second body member 112 may be sprayed to the other side of the electrode plate (E).

For example, each of the first body member 111 and the second body member 112 may include a cold air storage portion 111a, a cold air guide portion 111b, and a cold air spray portion 111c.

The cold air storage portion 111a may store a cold air supplied from the cold air supply member 113. The cold air storage portion 111a may store the cold air for a predetermined time.

The cold air guide portion 111b may communicate with the cold air storage portion 111a, and may protrude from a portion of the cold air storage portion 111a adjacent to the electrode plate (E). A portion of the cold air guide portion 111b adjacent to the electrode plate (E) may be inclined downwardly as it gradually approaches the hot air supply portion 120. For example, a shape of a vertical cross-section of a lower side of the cold air guide portion may be a triangular shape.

The cold air guide portion 111b may guide a flow of the cold air. Because the cold air is supplied to an upper portion of the cold air storage portion 111a based on a direction shown in the drawings, the cold air may be moved to a lower portion of the cold air storage portion 111a by a pressure difference. The cold air guide portion 111b may allow the cold air stored in the cold air storage portion 111a to naturally gather into the cold air spray portion 111c.

The cold air spray portion 111c may be disposed at one side of the cold air guide portion 111b to spray the cold air stored in the cold air storage portion 111a. The cold air spray portion 111c may be disposed on a surface of the cold air guide portion 111b facing the hot air supply portion 120. Accordingly, the cold air discharged through the cold air spray portion 111c may be quickly mixed with the hot air to be sprayed toward the same portion of the electrode plate (E).

Although not shown in the drawings, the cold air spray portion 111c may have a slit shape. The cold air spray portion 111c with the slit shape may be disposed parallel to the electrode plate (E). Accordingly, the cold air may be evenly sprayed at one side of the electrode plate (E).

As shown in FIG. 2, the cold air may be supplied to an upper portion of the cold air storage portion 111a to be stored for a predetermined time, may be guided by the cold air guide portion 111b, and then may be discharged through the cold air spray portion 111c.

A temperature of a gas sprayed from the above-described cold air supply portion 110 may range from 30 degrees above zero to 10 degrees below zero. The temperature of the gas sprayed from the cold air supply portion 110 may be selected by various variables such as a temperature of the hot air supply portion 120, a temperature of a work space, and the like, so that it is not limited to a specific temperature.

For example, the hot air supply portion 120 described above may include a hot air body member 121 and a hot air supply member 122.

The hot air body member 121 may be coupled to the first body member 111 and the second body member 112. The hot air body member 121 may be a member through which the hot air is sprayed to the electrode plate (E). This hot air body member 121 may have a size corresponding to a length of a width of the electrode plate (E), or may be relatively larger than the length of the width of the electrode plate (E). Accordingly, the hot air may be uniformly sprayed to an entire electrode plate (E).

The hot air supply member 122 may be connected to the hot air body member 121, and may supply the hot air to the hot air body member 121. The hot air supply member 122 may be a member (e.g., a heater, a boiler, or the like) that generates the hot air by heating a gas, but the present disclosure is not limited thereto.

For example, the above-described hot air body member 121 may include a hot air storage portion 121a, a hot air guide portion 121b, and a hot air spray portion 121c.

The hot air storage portion 121a may store the hot air supplied from the hot air supply member 122.

The hot air guide portion 121b may communicate with the hot air storage portion 121a, and may protrude from a portion of the hot air storage portion 121a adjacent to the electrode plate (E).

The hot air spray portion 121c may be disposed at one side of the hot air guide portion 121b to spray the hot air stored in the hot air storage portion 121a.

The hot air spray portion 121c may be disposed on a surface of the hot air guide portion 121b facing the cold air supply portion 110. Although not shown in the drawings, the hot air spray portion 121c may have a slit shape. The hot air spray portion 121c with the slit shape may be disposed parallel to the electrode plate (E). Accordingly, the hot air may be evenly sprayed at one side of the electrode plate (E).

A portion of the hot air guide portion 121b adjacent to the electrode plate (E) may be inclined downwardly as it gradually approaches the cold air supply portion 110. For example, a shape of a vertical cross-section of a lower side of the hot air guide portion may be a triangular shape.

The hot air guide portion 121b may guide a flow of the hot air. Because the hot air is continuously supplied to an upper portion of the hot air storage portion 121a based on a direction shown in the drawings, the hot air may be moved to a lower portion of the hot air storage portion 121a. The hot air guide portion 121b may allow the hot air stored in the hot air storage portion 121a to naturally gather into the hot air spray portion 121c.

The hot air supply portion 120 described above may dry the electrode plate (E) by spraying the hot air to the electrode plate (E).

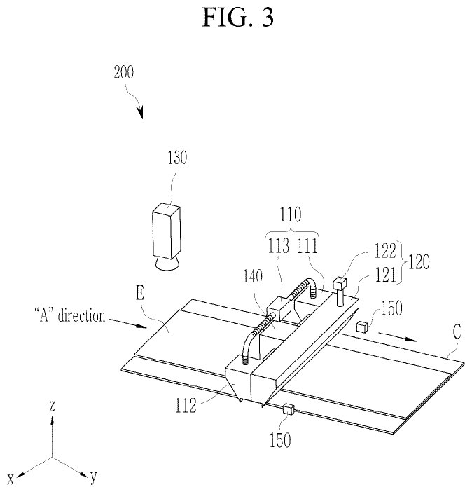

FIG. 3 is a perspective view showing a drying apparatus for manufacturing a rechargeable battery according to other embodiments of the present disclosure.

Referring to FIG. 3, the drying apparatus 200 for manufacturing the rechargeable battery according to the other embodiments of the present disclosure may further include a measurement member 130 and an interval adjustment portion (or an interval adjustment unit) 140.

The measurement member 130 may measure a length in a width direction of the electrode plate (E). A position at which the measurement member 130 is installed may be a position that faces the electrode plate (E) being transferred before the interval adjustment portion 140 that will be described later. For example, after the measurement member 130 measures the length in the width direction of the electrode, the interval adjustment portion 140 may be operated. A detailed description of the measurement member 130 for this purpose will be described later.

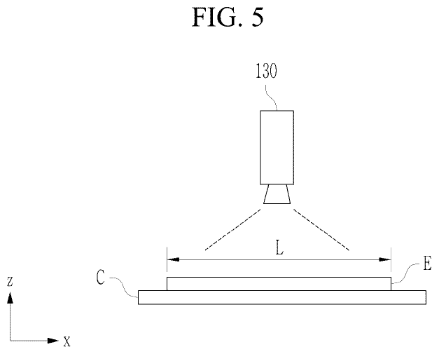

The interval adjustment portion 140 may adjust an interval between the first body member 111 and the second body member 112 based on a length value (L) of FIG. 5 measured in the measurement member 130. The drying apparatus 200 for manufacturing the rechargeable battery according to the other embodiments of the present disclosure may dry the electrode plate having various sizes, and a size of the hot air body member 121 may be a size corresponding to the relatively largest electrode plate (E).

The interval between the first body member 111 and the second body member 112 may be changed to correspond to the length of the width of the electrode plate (E) by the interval adjustment portion 140. To this end, the first body member 111 and the second body member 112 may be slidably coupled to the hot air supply portion 120.

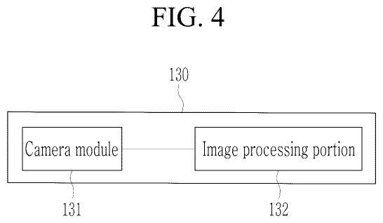

FIG. 4 is a block diagram showing the measurement member included in the drying apparatus for manufacturing the rechargeable battery, and FIG. 5 is a view showing a process in which the measurement member measures the length in the width direction of the electrode plate.

Referring to FIG. 4 and FIG. 5, for example, the measurement member 130 may include a camera module 131 and an image processing portion 132.

The camera module 131 may acquire image data by photographing the electrode plate (E).

The image processing portion 132 may calculate the length value (L) by analyzing the image data acquired by the camera module 131. For example, the image processing portion 132 may calculate the length value (L) by measuring the number of pixels occupied by the width of the electrode plate (E) in the image data.

Although not shown in the drawings, the measurement member 130 according to a modified example may include a laser module (not shown). The laser module may measure the length value (L) by irradiating the electrode plate (E) with a laser.

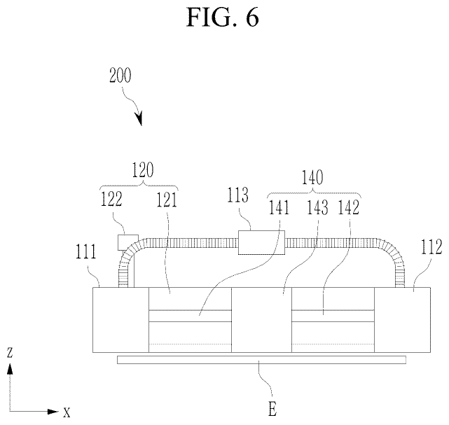

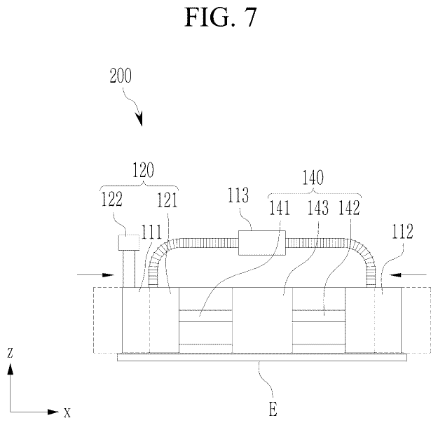

FIG. 6 is a view showing a state before the first body member and the second body member become close to each other by the interval adjustment portion, and FIG. 7 is a view showing a state in which the first body member and the second body member become close to each other by the interval adjustment portion.

Referring to FIG. 6 and FIG. 7, for example, the above-described interval adjustment portion 140 may include a first shaft member 141, a second shaft member 142, and a driving member 143.

The first shaft member 141 may be coupled to the first body member 111. The first shaft member 141 may be fixedly coupled to a portion of the first body member 111 facing the second shaft member 142.

The second shaft member 142 may be coupled to the second body member 112. The second shaft member 142 may be fixedly coupled to a portion of the second body member 112 facing the first shaft member 141.

The driving member 143 may move the first shaft member 141 and the second shaft member 142 so that the first body member 111 and the second body member 112 are moved away from or close to the interval adjustment portion 140. An operation method of the driving member 143 may be various methods such as a hydraulic cylinder, a pneumatic cylinder, a linear motor and a rack and a pinion, and the like.

As shown in FIG. 7, the above-described measurement member 130 may transmit the length value (L) of FIG. 5 to the interval adjustment portion 140, and the driving member 143 of the interval adjustment portion 140 may adjust an interval between the first body member 111 and the second body member 112 to correspond to the transmitted length value (L) of FIG. 5. Accordingly, as the first body member 111 and the second body member 112 respectively correspond to both sides of the electrode plate (E), the cold air may be sprayed to both sides of the electrode plate (E).

Referring back to FIG. 3, the drying apparatus 200 for manufacturing the rechargeable battery according to the other embodiments of the present disclosure may further include a temperature sensor 150.

The temperature sensor 150 may be installed adjacent to the electrode plate (E), and may measure temperatures of a central portion and both sides of the electrode plate (E). There may be one or more temperature sensors 150. If the temperature sensor 150 is provided in a plural number, each of the plurality of temperature sensors 150 may divide the electrode plate (E) into three parts in the width direction to measure a temperature for each region.

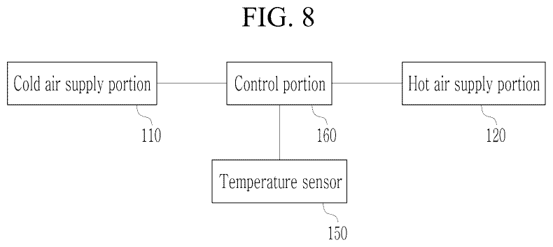

FIG. 8 is a block diagram showing a drying apparatus for manufacturing a rechargeable battery according to other embodiments of the present disclosure.

Referring to FIG. 8, the drying apparatus 200 for manufacturing the rechargeable battery according to the other embodiments of the present disclosure may further include a control portion 160.

The control portion 160 may be electrically connected to the temperature sensor 150 and the cold air supply portion 110. The control portion 160 may adjust a temperature of the cold air sprayed from the cold air supply portion 110 so that the temperatures of the central portion and the both sides of the electrode plate (E) reach a target temperature based on a temperature value measured by the temperature sensor 150.

The control portion 160 may be electrically connected to the temperature sensor 150 and the hot air supply portion 120. The control portion 160 may adjust a temperature of the hot air sprayed from the hot air supply portion 120 so that the temperatures of the central portion and the both sides of the electrode plate (E) reach a target temperature based on a temperature value measured by the temperature sensor 150. Here, the target temperature at which the entire electrode plate (E) may be uniformly dried may be obtained through an experiment, so that the target temperature is not limited to a specific temperature.

Referring back to FIG. 1, the drying apparatus 100 for manufacturing the rechargeable battery according to the embodiments of the present disclosure described above may include the cold air supply portion 110 to uniformly dry the entire electrode plate (E) compared with a conventional drying apparatus. For example, the drying apparatus 100 for manufacturing the rechargeable battery according to the embodiments of the present disclosure may adjust a drying quality of the electrode plate (E) through thermal balance by adding the cold air to both sides of the electrode plate (E) that receive relatively more heat than a central portion thereof.

It may be confirmed through the following drying experiment that the drying apparatus 100 for manufacturing the rechargeable battery according to the embodiments of the present disclosure dries the electrode plate (E) more uniformly than the conventional drying apparatus.

In the drying experiment, a remaining amount of a solvent is measured after the electrode plate (E) is dried using each of the drying apparatus according to the embodiments and a drying apparatus according to a comparative example.

The drying apparatus according to the embodiments is the drying apparatus including the cold air supply portion 110 shown in FIG. 1. The drying apparatus according to the comparative example is a drying apparatus that includes only the hot air supply portion without the cold air supply portion.

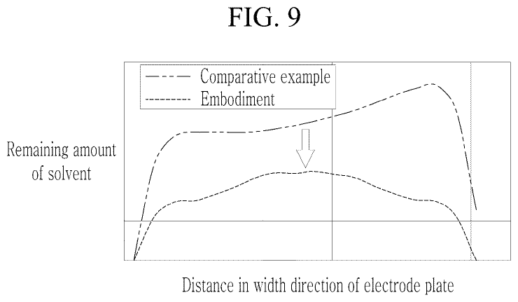

FIG. 9 is a graph showing an experimental result comparing the remaining amount of the solvent according to a region of the electrode plate dried by the drying apparatus according to the embodiments with the remaining amount of the solvent according to a region of the electrode plate dried by the drying apparatus according to the comparative example.

In the graph of FIG. 9, an x-axis value represents a displacement in the width direction of the electrode plate, and a center portion thereof is a center of the electrode plate. A y-axis value of FIG. 9 is the remaining amount of the solvent remaining at the electrode plate. In the graph, each of the x-axis value and the y-axis value is expressed as an absolute value without a separate numeric value.

Referring to FIG. 9, in a case of the drying apparatus according to the comparative example, a large difference in the remaining amount of the solvent between the central portion and both side portions of the electrode plate is observed. However, in a case of the drying apparatus according to the embodiments, a relatively small difference in the remaining amount of the solvent between the central portion and both side portions of the electrode plate is observed. In addition, it is observed that the remaining amount of the solvent of the drying apparatus according to the embodiments is lower than that of the drying apparatus according to the comparative example.

As described above, it may be confirmed that the drying apparatus according to the embodiments dries the center and both sides of the electrode plate more uniformly than the drying apparatus according to the comparative example.

Although various embodiments of the present disclosure have been described, the drawings and the detailed description that are described above are merely illustrative, are used only for a purpose of describing the present disclosure, and are not used for limiting a meaning or a scope of the present disclosure disclosed in the claims. Therefore, a person skilled in the art will understand that various modifications and other equivalent embodiments may be derived therefrom. Thus, a true technical protection scope of the present disclosure should be determined by a technical idea of the appended claims.

### DESCRIPTION OF SYMBOLS

| | |
|---|---|
| 100, 200: drying apparatus for | |
| manufacturing rechargeable battery | |
| 110: cold air supply portion | 111: first body member |
| 112: second body member | 113: cold air supply member |
| 111a: cold air storage portion | 111b: cold air guide portion |
| 111c: cold air spray portion | 120: hot air supply portion |
| 121: hot air body member | 122: hot air supply member |
| 121a: hot air storage portion | 121b: hot air guide portion |
| 121c: hot air spray portion | 130: measurement member |
| 131: camera module | 132: image processing portion |
| 140: interval adjustment portion | 141: first shaft member |
| 142: second shaft member | 143: driving member |
| 150: temperature sensor | 160: control portion |

What is claimed is:

1. A drying apparatus for manufacturing a rechargeable battery, comprising:
a hot air supply portion that supplies hot air to an electrode plate; and
a cold air supply portion that supplies cold air to both sides along a width direction of the electrode plate.

2. The drying apparatus for manufacturing the rechargeable battery as claimed in claim 1, wherein the cold air supply portion comprises:
a first body member that is coupled to one side of the hot air supply portion;
a second body member that is coupled to another side of the hot air supply portion; and
a cold air supply member that is connected to the first body member and the second body member and supplies a cold air to the first body member and the second body member.

3. The drying apparatus for manufacturing the rechargeable battery as claimed in claim 2, wherein each of the first body member and the second body member comprises:
a cold air storage portion in which the cold air supplied from the cold air supply member is stored;
a cold air guide portion that communicates with the cold air storage portion and protrudes from a portion of the cold air storage portion adjacent to the electrode plate; and
a cold air spray portion that is disposed at one side of the cold air guide portion to spray the cold air stored in the cold air storage portion.

4. The drying apparatus for manufacturing the rechargeable battery as claimed in claim 3, wherein the cold air spray portion is disposed on a surface of the cold air guide portion facing the hot air supply portion.

5. The drying apparatus for manufacturing the rechargeable battery as claimed in claim 3, wherein the cold air spray portion has a slit shape.

6. The drying apparatus for manufacturing the rechargeable battery as claimed in claim 3, wherein a portion of the cold air guide portion adjacent to the electrode plate is inclined downwardly as the portion of the cold air guide portion adjacent to the electrode plate gradually approaches the hot air supply portion.

7. The drying apparatus for manufacturing the rechargeable battery as claimed in claim 3, wherein the hot air supply portion comprises:
a hot air body member that is coupled to the first body member and the second body member; and
a hot air supply member that is connected to the hot air body member and supplies a hot air to the hot air body member.

8. The drying apparatus for manufacturing the rechargeable battery as claimed in claim 7, wherein the hot air body member comprises:
a hot air storage portion in which the hot air supplied from the hot air supply member is stored;
a hot air guide portion that communicates with the hot air storage portion and protrudes from a portion of the hot air storage portion adjacent to the electrode plate; and
a hot air spray portion that is disposed at one side of the hot air guide portion to spray the hot air stored in the hot air storage portion.

9. The drying apparatus for manufacturing the rechargeable battery as claimed in claim 8, wherein the hot air spray portion is disposed on a surface of the hot air guide portion facing the cold air supply portion.

10. The drying apparatus for manufacturing the rechargeable battery as claimed in claim 8, wherein the hot air spray portion has a slit shape.

11. The drying apparatus for manufacturing the rechargeable battery as claimed in claim 8, wherein a portion of the hot air guide portion adjacent to the electrode plate is inclined downwardly as the portion of the hot air guide portion adjacent to the electrode plate gradually approaches the cold air supply portion.

12. The drying apparatus for manufacturing the rechargeable battery as claimed in claim 1, wherein a temperature of a gas sprayed from the cold air supply portion ranges from 30 degrees above zero to 10 degrees below zero.

13. The drying apparatus for manufacturing the rechargeable battery as claimed in claim 2, further comprising:
a measurement member that measures a length in the width direction of the electrode plate; and
an interval adjustment portion that adjusts an interval between the first body member and the second body member based on a length value measured by the measurement member.

14. The drying apparatus for manufacturing the rechargeable battery as claimed in claim 13, wherein the first body member and the second body member are slidably coupled to the hot air supply portion.

15. The drying apparatus for manufacturing the rechargeable battery as claimed in claim 13, wherein the measurement member comprises a laser module that measures the length value by irradiating the electrode plate with a laser.

16. The drying apparatus for manufacturing the rechargeable battery as claimed in claim 13, wherein the measurement member comprises:
a camera module that acquires image data by photographing the electrode plate; and
an image processing portion that calculates the length value by analyzing the image data acquired by the camera module.

17. The drying apparatus for manufacturing the rechargeable battery as claimed in claim 13, wherein the interval adjustment portion comprises:
a first shaft member that is coupled to the first body member;
a second shaft member that is coupled to the second body member; and
a driving member that moves the first shaft member and the second shaft member so that the first body member and the second body member are moved away from or close to the interval adjustment portion.

18. The drying apparatus for manufacturing the rechargeable battery as claimed in claim 1, further comprising a temperature sensor that is installed adjacent to the electrode plate and measures temperatures of a central portion and both sides of the electrode plate.

19. The drying apparatus for manufacturing the rechargeable battery as claimed in claim 18, further comprising a control portion that is electrically connected to the temperature sensor and the cold air supply portion and adjusts a temperature of the cold air sprayed from the cold air supply portion so that the temperatures of the central portion and the both sides of the electrode plate reach a target temperature based on a temperature value measured by the temperature sensor.

20. The drying apparatus for manufacturing the rechargeable battery as claimed in claim 18, further comprising a control portion that is electrically connected to the temperature sensor and the hot air supply portion and adjusts a temperature of the hot air sprayed from the hot air supply portion so that the temperatures of the central portion and the both sides of the electrode plate reach a target temperature based on a temperature value measured by the temperature sensor.
